(19) United States
(12) Patent Application Publication
(10) Pub. No.: US 2026/0260201 A1
(43) Pub. Date: Sep. 3, 2026

(54) SYSTEMS AND METHODS FOR SETTING ORDER OF CARGO SHIPMENT

(71) Applicant: TOTAL SOFT BANK LTD., Busan (KR)

(72) Inventor: Hoon LEE, Busan (KR)

(21) Appl. No.: 19/653,352

(22) Filed: Apr. 21, 2026

Related U.S. Application Data
(63) Continuation-in-part of application No. 17/294,869, filed on Nov. 18, 2019.

(30) Foreign Application Priority Data
Nov. 19, 2018 (KR) 10-2018-0142335

(51) Int. Cl. G06Q 10/0831; G01B 17/06; G01C 21/20; G05B 17/02; G06Q 10/047

(52) U.S. Cl. CPC G06Q 10/0831; G01B 17/06; G01C 21/20; G05B 17/02; G06Q 10/047

(57) ABSTRACT

Systems and methods for setting order of cargo shipment are described. According to one embodiment, an autonomous robotic cargo management system for internal ship logistics comprises a multi spectral sensor suite configured to measure three-dimensional profiles of cargoes within a ship, at least one autonomous robotic carrier to move the cargoes to destinations within the ship, a computer processor, a memory, and a navigation control system, wherein the system is configured to stably set the order of cargo shipment through a feedback process.

### CROSS-REFERENCE TO RELATED APPLICATIONS

This is a continuation-in-part application of the U.S. Utility Patent Application No. 17/294,869 filed on Jun. 8, 2021, which is a national phase of International Application No. PCT/KR2019/015756 filed on Nov. 18, 2019 and claims priority from Korean Patent Application No. 10-2018-0142335, filed on Nov. 19, 2018, which is incorporated herein by reference in its entirety.

### FIELD OF THE DISCLOSURE

The present disclosure relates to systems and methods for setting order of cargo shipment, and more particularly, to methods and systems for setting order of cargo shipment through a feedback process.

### BACKGROUND OF THE DISCLOSURE

The order that cargo is loaded on a ship may be varied according to size of loaded cargo and shape of the ship. If the order of cargo shipment is not planned, shipment efficiency of cargo may become relatively low and temporal and financial damages may occur. According to a conventional method or device for setting order of cargo shipment, the order of cargo shipment may be set according to a feed-forward method. However, if an error occurs in order of cargo shipment, the order of cargo shipment must be reset, but it may lower efficiency. After the order of cargo shipment is set, measures for stably setting order of cargo shipment by simulating the set order of cargo shipment to give feedback.

### SUMMARY OF THE DISCLOSURE

This summary is provided to introduce a selection of concepts in a simplified form that are further described below in the detailed description. This summary is not intended to identify key features or essential features of the claimed subject matter, nor is it intended to be used to limit the scope of the claimed subject matter.

Accordingly, the present disclosure has been made in an effort to solve the above-mentioned problems occurring in the prior arts, and it is an object of the present disclosure to provide systems and methods for stably setting order of cargo shipment through a feedback process. Technical objects to be achieved by the present disclosure are not limited to the above-described objects and other technical objects that have not been described will be evidently understood by those skilled in the art from the following description.

To achieve the above objects, according to one embodiment, the present disclosure provides an autonomous robotic cargo management system for internal ship logistics. The system comprises a multi-spectral sensor suite comprising an ultrasonic dimensioning sensor, wherein the multi-spectral sensor suite configured to measure three-dimensional profiles of cargoes within a ship. The system also comprises at least one autonomous robotic carrier to move the cargoes to destinations within the ship, wherein each one of the at least one autonomous robotic carrier comprises a drive system and a wireless transceiver for receiving navigation commands.

In addition, the system comprises a computer processor and a memory storing instructions that, when executed, cause the computer processor to receive preliminary data of the cargoes and static ship structure data identifying fixed internal obstacles including pillars and ramps within the ship; synchronize the static ship structure data with dynamic telemetry data from the at least one autonomous robotic carrier; calculate a numerical collision probability value for movement route of each cargo by executing a predictive interference analysis between a projected kinematic path of each autonomous robotic carrier carrying the each cargo and an occupancy volume of the static ship structure data and a three-dimensional profile of the each cargo; validate a preliminary cargo shipment order of the each cargo if the numerical collision probability value for the movement route of the each cargo is below a threshold value and confirms a destination reachability, wherein the preliminary cargo shipment order of the each cargo is generated by fusing at least the preliminary data of the cargoes with the static ship structure data; and adjust the preliminary cargo shipment order in real-time by performing a path re-calculation if the multi-spectral sensor suite detects a dynamic obstacle.

The system further comprises a navigation control system configured to autonomously direct each autonomous robotic carrier by transmitting low-latency control signals to each autonomous robotic carrier to execute the validated or adjusted cargo shipment order.

To achieve the above objects, according to another embodiment, the present disclosure provides a method of an autonomous robotic cargo management system for internal ship logistics, wherein the autonomous robotic cargo management system includes a multi spectral sensor suite comprising an ultrasonic dimensioning sensor, the multi-spectral sensor suite configured to measure three-dimensional profiles of cargoes within a ship, at least one autonomous robotic carrier to move the cargoes to destinations within the ship and each one of the at least one autonomous robotic carrier comprising a drive system and a wireless transceiver for receiving navigation commands, a computer processor, a memory, and a navigation control system.

The memory is configured to store instructions that, when executed, cause the computer processor to perform the method comprising receiving preliminary data of the cargoes and static ship structure data identifying fixed internal obstacles including pillars and ramps within the ship; synchronizing the static ship structure data with dynamic telemetry data from the at least one autonomous robotic carrier; calculating a numerical collision probability value for movement route of each cargo by executing a predictive interference analysis between a projected kinematic path of each autonomous robotic carrier carrying the each cargo and an occupancy volume of the static ship structure data and a three-dimensional profile of the each cargo; validating a preliminary cargo shipment order of the each cargo if the numerical collision probability value for the movement route of the each cargo is below a threshold value and confirms a destination reachability, wherein the preliminary cargo shipment order of the each cargo is generated by fusing at least the preliminary data of the cargoes with the static ship structure data; adjusting the preliminary cargo shipment order in real-time by performing a path re-calculation if the multi-spectral sensor suite detects a dynamic obstacle; and transmitting low-latency control signals to the each autonomous robotic carrier to execute the preliminary cargo shipment order to autonomously direct the each autonomous robotic carrier using the navigation control system.

The systems and methods for setting order of cargo shipment according to the present disclosure can stably set the order of cargo shipment through a feedback process. The effects of the present disclosure are not limited to the above-mentioned effect and further effects derivable from the detailed description of disclosure or claims of the present disclosure will be clearly understood by those skilled in the art.

### BRIEF DESCRIPTION OF THE DRAWINGS

These and other features, aspects and advantages of the present disclosure will become better understood with reference to the accompanying drawings, wherein:

FIG. 1 illustrate a system for setting an order of cargo shipment according to one embodiment of the present disclosure.

FIGS. 2A-2B are views showing a device for setting order of cargo shipment according to one embodiment of the present disclosure.

FIGS. 2A-2B are views showing a ship capable of shipping cargo.

FIG. 3A is a view showing contents of a cargo table and FIG. 3B is a view illustrating cargoes of the ship grouped by their sizes.

FIGS. 4A-4B are views showing a ship on which cargo shipment zones are indicated.

FIG. 5 is a view showing the cargo shipment zones in consideration of a cargo movement route.

FIGS. 6A-6C are views showing execution of simulation related with cargo shipment.

FIG. 7 is a view showing the ship on which cargo is loaded.

FIGS. 8 to 11 are flow charts showing a cargo shipping method according to one embodiment of the present disclosure.

FIG. 12 illustrate another system for setting an order of cargo shipment according to one embodiment of the present disclosure.

FIG. 13 is a flow chart showing another cargo shipping method according to one embodiment of the present disclosure.

FIG. 14 illustrate yet another system for setting an order of cargo shipment according to one embodiment of the present disclosure.

FIG. 15 is a flow chart showing yet another cargo shipping method according to one embodiment of the present disclosure.

### DETAILED DESCRIPTION OF THE DISCLOSURE

Hereinafter, the present disclosure will be described in detail with reference to the accompanying drawings. However, embodiments of the present disclosure may be implemented in several different forms and are not limited to the embodiments described herein. In addition, parts irrelevant to description are omitted in the drawings in order to clearly explain embodiments of the present disclosure. Similar parts are denoted by similar reference numerals throughout this specification.

Throughout this specification, when a part is referred to as being “connected” to another part, this includes “direct connection” and “indirect connection” via an intervening part. Also, when a certain part “includes” a certain component, other components are not excluded unless explicitly described otherwise, and other components may in fact be included.

The terminology used herein is for the purpose of describing particular embodiments only and is not intended to be limiting of the inventive concept. As used herein, the singular forms “a”, “an”, and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

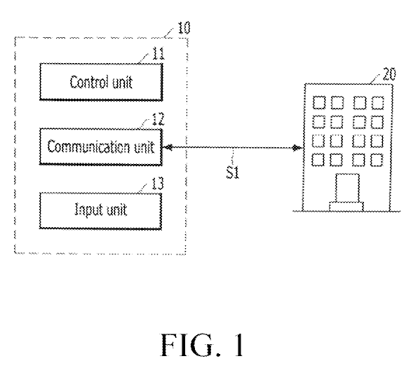

FIG. 1 is a view showing a cargo shipment zone setting system according to a preferred embodiment of the present disclosure. The cargo shipment zone setting system 10 may be called a “cargo shipment order setting system” or a “cargo shipment order setting device”. Referring to FIG. 1, the cargo shipment zone setting system 10 according to the preferred embodiment of the present disclosure may be implemented using a server. The server may be implemented using a computer, a laptop, a PCB, or a logic circuit. The cargo shipment zone setting system 10 includes a control unit 11. The control unit 11 carries out operation or simulation. The control unit 11 carries out preset programs. The control unit 11 may be a “processor”.

The cargo shipment zone setting system 10 includes a communication unit 12. The communication unit 12 communicates with an external device. For instance, the communication unit 12 sends and receives information and/or signals to and from an external organization 20. For instance, the external organization 20 may be an organization which manages cargo movement between a harbor and a ship. The communication unit 12 can send and receive a first signal S1 to and from the external organization 20. For instance, the communication unit 12 receives the first signal S1 from the external organization 20 and transfer it to the control unit 11. The cargo shipment zone setting system 10 includes an input unit 13. The input unit 13 is connected to the control unit 11. The input unit 13 acquires an input from a user and transfers it to the control unit 11. The input acquired by the input unit 13 includes command information related with controls of the control unit 11.

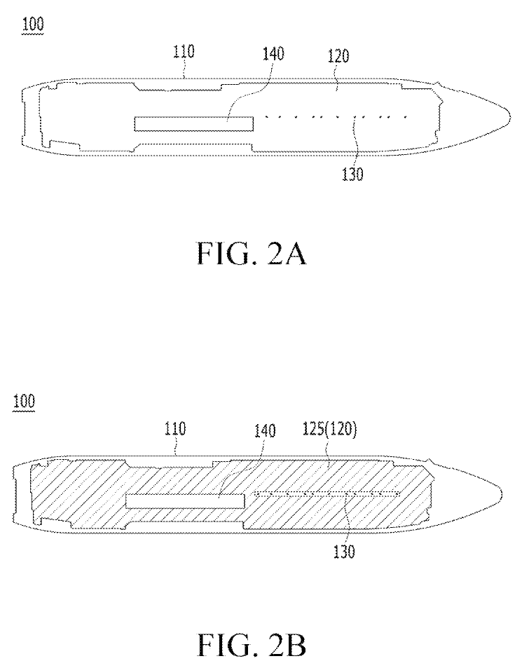

FIGS. 2A-2B are views showing a ship capable of shipping cargo. FIGS. 2A-2B are top views of the ship. FIG. 2A is a top view of a ship 100 for shipping cargo. FIG. 2B shows cargo shippable zones 125 in the ship 100 indicated in FIG. 2A. Referring to FIG. 2A, the ship 100 includes a hull 110. The hull 110 forms a frame of the ship 100. The hull 110 has a receiving space formed therein. Moreover, the hull 110 has a space for shipment formed at the top thereof. The ship 100 has a deck 120. The deck 120 forms an upper surface of the ship 100. The deck 120 has a space for receiving cargo. The deck is horizontal. The deck 120 may be divided into several zones. The ship 100 includes pillars 130. Devices necessary for managing the ship 100 are mounted on the pillars 130. A plurality of the pillars 130 are provided. The pillars 130 are located on the deck 120. The pillars 130 extend upwards from the deck 120. The ship 100 includes a ramp 140. The ramp 140 is used to move cargo from the deck 120. The ramp 140 is located on the deck 120. The ramp 140 is to load or unload cargo from a port.

Referring to FIG. 2B, the entire zone of the deck 120 is divided into cargo shippable zones 125 and cargo unshippable zones. The cargo shippable zone 125 means a zone on which cargo can be loaded theoretically. Structures located on the deck 120 excludes spaces on which cargo is loaded. For instance, the ramp 140 or the pillars 130 may remove the spaces that cargo is shipped on the deck 120. The communication unit 12 (refer to FIG. 1) acquires structure-related information of the ship 100 from the external organization 20 (refer to FIG. 1). For instance, the first signal S1 (refer to FIG. 1) calculates the cargo shippable zones 125 on the basis of the structure-related information of the ship 100. The structure-related information of the ship 100 may include preliminary data. The cargo shippable zone 125 may not mean a shippable zone for all kinds of cargo. For instance, relative bulky cargo cannot be shipped in a narrow space, but small cargo can be shipped in a narrow space. That is, in order to calculate a zone for shipping cargo on the deck 120, the cargo shippable zones 125 and information on actual cargo may be required.

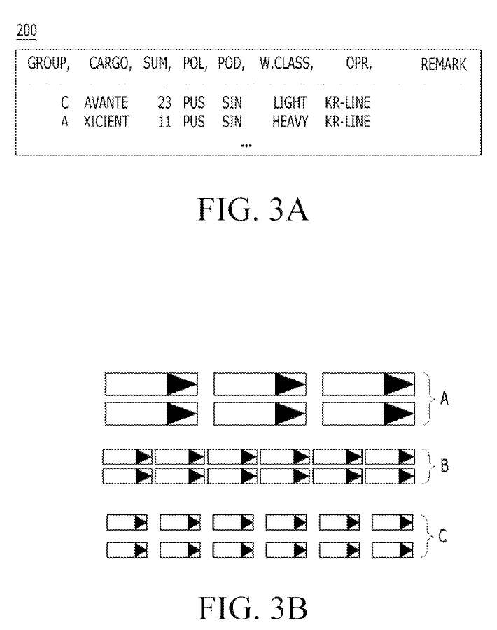

FIG. 3A is a view showing contents of a cargo table 200. Referring to FIG. 3, the cargo table 200 has a plurality of fields. For instance, a plurality of the fields include group, kind of cargo, sum, pol, pod, weight class, and so on. The communication unit 12 (refer to FIG. 1) receives the first signal S1 (refer to FIG. 1) containing information on the cargo table 200. The cargo table 200 may be included in the preliminary data. Referring to FIG. 3B, cargo of each group may be indicated by different sizes. For instance, an A group cargo (A) which is a large-sized truck is indicated relatively largely. A C group cargo (C) which is a car is indicated relatively small. A B group cargo (B) which is a middle-sized truck is indicated in a medium size. For the convenience of description, it may be assumed that the A group cargo (A), the B group cargo (B), and the C group cargo (C) are shipped on the ship 100 (refer to FIG. 1). The information on the cargo shippable zones 125 and the data including the cargo table 200 is called a “first data”. The control unit 11 (refer to FIG. 1) generates the first data based on the structure-related information of the ship 100.

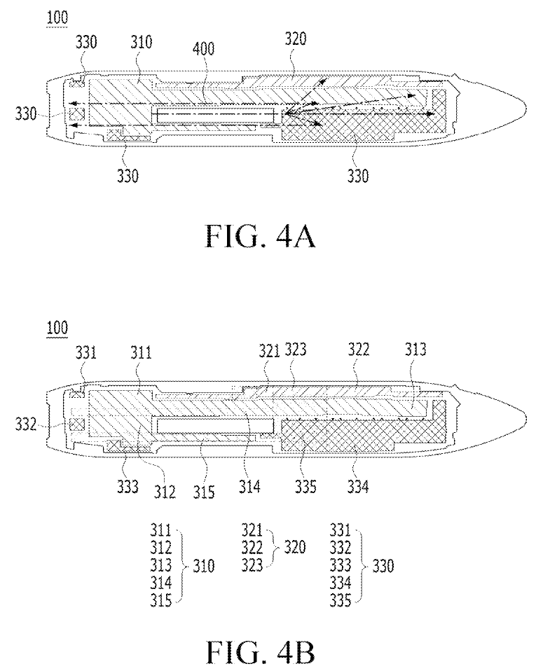

FIGS. 4A-4B are views showing a ship 100 on which cargo shipment zones are indicated. Referring to FIGS. 4A-4B, the cargo shipment zones 310, 320 and 330 are zones allotted to cargo of each group among the cargo shippable zones 125 (refer to FIGS. 2A-2B) of the ship 100 in consideration of the cargo table 200 (refer to FIG. 3B). For instance, the A zone 310 may mean a zone in which the A group cargo (A) (refer to FIG. 3B) is shipped. The B zone 320 may mean a zone in which the B group cargo (B) (refer to FIG. 3B) is shipped. The C zone 330 may mean a zone in which the C group cargo (C) (refer to FIG. 3B) is shipped.

The data containing the information on the cargo shipment zones 310, 320 and 330 is called a “second data”. The cargo shipment zones 310, 320 and 330 may be set in consideration of order of bulky cargo among the shipped cargo. The control unit 11 (refer to FIG. 1) generates the second data based on the information on the cargo table 200 included in the first signal S1 (refer to FIG. 1) and the first data. For instance, because the A group cargo (A) (refer to FIG. 3B) is the large-sized truck which is relatively bulky, The A group cargo (A) (refer to FIG. 3B) may be considered preferentially in setting the cargo shipment zones 310, 320 and 330. After that, because the B group cargo (B) is the middle-sized truck which is relatively bulky, the B group cargo (B) (refer to FIG. 3B) may be considered suboptimally. After that, the C group cargo (C) (refer to FIG. 3B) may be considered finally.

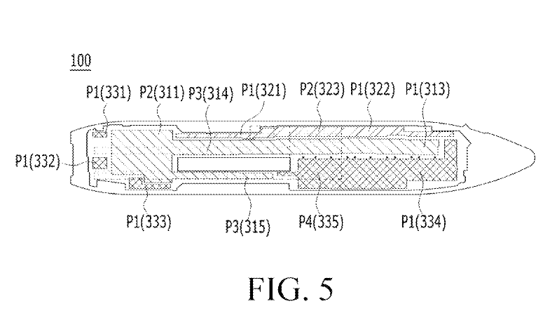

FIG. 5 is a view showing the cargo shipment zones in consideration of a cargo movement route. Referring to FIG. 4A, a cargo movement route 400 is indicated. It may be difficult to directly move cargo from a port to a designated location of the ship 100. Therefore, the cargo is moved to a temporary location of the ship 100, and then, is moved to the designated location. For instance, the cargo is moved to the ramp 140 (refer to FIGS. 2A-2B) of the ship 100, and then, is moved to the designated location. Data including information on the cargo movement route 400 in the ship 100 is called a “third data”.

Referring to FIG. 4B, “subdivided cargo shipment zones” considering the cargo movement route 400 may be indicated. The cargo movement route 400 forms boundary with the cargo shipment zones 310, 320 and 330. The cargo shipment zones 310, 320 and 330 are sorted as the “subdivided cargo shipment zones” by the boundary. Data including information on the “subdivided cargo shipment zones” is called a “fourth data”. The control unit 11 (refer to FIG. 1) generates the third data based on the second data. The control unit 11 (refer to FIG. 1) generates the fourth data based on the third data. If the first cargo is located on the cargo movement route 400, the first cargo may obstruct movement of the second cargo. Therefore, the cargo shipment zones 310, 320 and 330 are subdivided in consideration of the cargo movement route 400, and cargo is shipped depending on the subdivided cargo shipment zones. For instance, the A zone 310 may be subdivided into a first A zone 311, a second A zone 312, a third A zone 313, a fourth A zone 314, and a fifth A zone 315. For instance, the B zone 320 may be subdivided into a first B zone 321, a second B zone 322, a third B zone 323, a fourth B zone 324, and a fifth B zone 325. For instance, the C zone 330 may be subdivided into a first C zone 331, a second C zone 332, a third C zone 333, a fourth C zone 334, and a fifth C zone 335.

The “subdivided cargo shipment zones” illustrated in FIG. 5 may be divided into “subdivided cargo shipment zones having order of priority.” Data including information on “subdivided cargo shipment zones having order of priority” is called a “fifth data”. The control unit 11 (refer to FIG. 1) generates the fifth data based on the fourth data. The fifth data is called “preliminary cargo shipment order data”. For instance, the “subdivided cargo shipment zones P1, P2, P3 and P4 having order of priority” include a first priority zone P1, a second priority zone P2, a third priority zone P3, and a fourth priority zone P4. The “subdivided cargo shipment zones P1, P2, P3 and P4 having order of priority” mean that order of priority is applied to the subdivided cargo shipment zones 310, 320 and 330 (refer to FIG. 5).

If cargo is shipped in the second to fourth priority zones P2 to P4 before cargo is shipped in the first priority zone P1, it may be difficult to move cargo which must be located in the first priority zone P2. If cargo is shipped in the third and fourth priority zones P3 and P4 before cargo is shipped in the second priority zone P2, it may be difficult to move cargo which must be located in the second priority zone P2. If cargo is shipped in the fourth priority zone P4 before cargo is shipped in the third priority zone P3, it may be difficult to move cargo which must be located in the third priority zone P3.

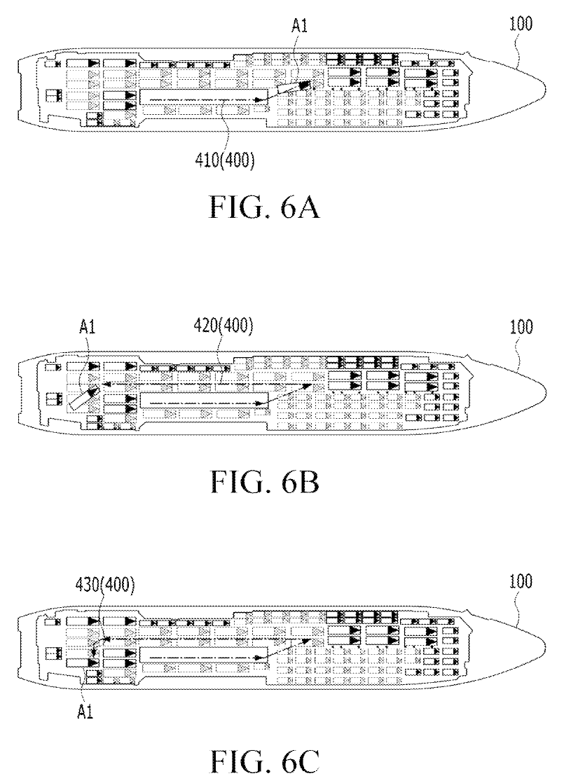

FIGS. 6A-6C are views showing execution of simulation related with cargo shipment. Referring to FIG. 6A, the first A cargo A1 can move forwards along a forward movement route 410 after being put on the ramp 140 (refer to FIG. 1). Referring to FIG. 6B, the first A cargo A1 can move backwards along a backward movement route 420. Referring to FIG. 6C, the first A cargo A1 can rotate along a rotational movement route 430 and is located in position in a proper position.

Referring to FIGS. 5 and 6A-6C, a destination of the first A cargo A1 may be the second priority zone P2. Therefore, in movement of the first A cargo A1, the third and fourth priority zones P3 and P4 may be required. Because there is no cargo in the third and fourth priority zones P3 and P4, the first A cargo A1 can be moved to the destination. Such simulation may be executed by the control unit 11 (refer to FIG. 1).

If there is a lack of a space for shipment as a result of the simulation, the control unit 11 (refer to FIG. 1) regenerates the second data, and renews from the third data to the fifth data based on the second data. If there is a collision probability on the cargo movement route as a result of the simulation, the control unit 11 (refer to FIG. 1) regenerates the third data, and renews from the fourth data to the fifth data based on the third data. If the cargo shipment zones are not effective as a result of the simulation, the control unit 11 (refer to FIG. 1) regenerates the fourth data, and renews the fifth data based on the fourth data. If the cargo does not reach the destination as a result of the simulation, the control unit 11 (refer to FIG. 1) regenerates the fifth data.

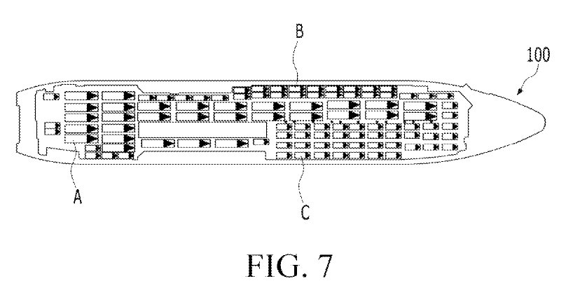

FIG. 7 is a view showing the ship on which cargo is loaded. FIG. 7 illustrates that all kinds of cargo are shipped on the ship 100 through the simulation illustrated in FIGS. 6A-6C. If it is verified that the fifth data is effective through the simulation, the control unit 11 (refer to FIG. 1) can set the fifth data as “cargo shipment order data”. The cargo shipment order data includes information on “cargo shipment order”. The cargo shipment order data may be called “determined cargo shipment order data”. The control unit 11 (refer to FIG. 1) provides the cargo shipment order data to the communication unit 12 (refer to FIG. 1). The communication unit 12 (refer to FIG. 1) transfers the cargo shipment order data to the external organization 20 (refer to FIG. 1). In this instance, the first signal S1 (refer to FIG. 1) includes the cargo shipment order data.

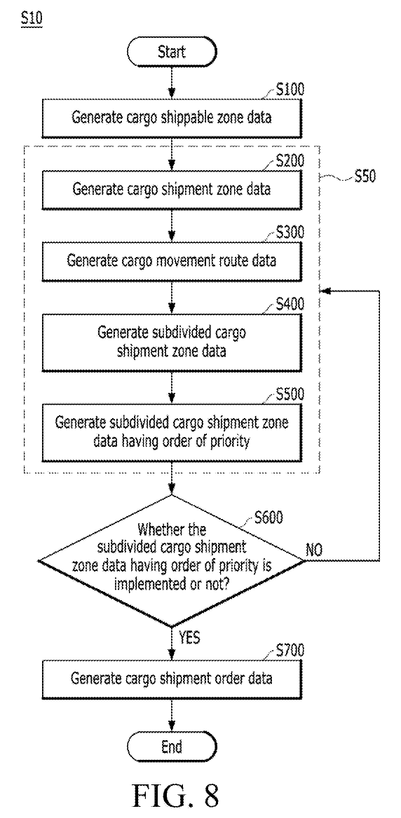

FIGS. 8 to 11 are flow charts showing a “cargo shipment method” according to the preferred embodiment of the present disclosure. The cargo shipment method S10 according to the preferred embodiment of the present disclosure includes a step (S100) of generating cargo shippable zone data. The step (S100) may be called a first step (S100) and is carried out by the control unit 11 (refer to FIG. 1). The control unit 11 (refer to FIG. 1) acquires the structure-related information of the ship 100 (refer to FIGS. 2A-2B) and the cargo table 200 (refer to FIG. 3A) from the external organization 200 (refer to FIG. 3). The control unit 11 (refer to FIG. 1) generates cargo shippable zone data on the basis of the structure-related information of the ship 100 (refer to FIGS. 2A-2B) and the cargo table 200 (refer to FIG. 3A). The cargo shippable zone data may be called the first data.

The cargo shipment method (S10) according to the preferred embodiment of the present disclosure includes a planning step (S50). The control unit 11 (refer to FIG. 1) carries out the planning step (S50). In the planning step (S50), the control unit 11 (refer to FIG. 1) can set order of cargo shipment based on the first data. The planning step (S50) includes second to fifth steps (S200, S300, S400 and S500) which will be described later. The cargo shipment method (S10) according to the preferred embodiment of the present disclosure includes a step (S200) of generating cargo shipment zone data. The step (S200) of generating cargo shipment zone data is included in the planning step (S50). The step (S200) of generating cargo shipment zone data is carried out by the control unit 11 (refer to FIG. 1). The cargo shipment zone data may be called the second data. In the step (S200), the control unit 11 (refer to FIG. 1) generates the second data based on the first data. The step (S200) may be called a second step (S200). The second data generated in the step (S200) may correspond to the cargo shipment zones 310, 320 and 33 illustrated in FIGS. 4A-4B.

The cargo shipment method (S10) according to the preferred embodiment of the present disclosure includes a step (S300) of generating cargo movement route data. The step (S300) of generating cargo movement route data is included in the planning step (S50). The step (S300) is carried out by the control unit 11 (refer to FIG. 1). The cargo movement route data may be called the third data. In the step (S300), the control unit 11 (refer to FIG. 1) generates the third data based on the second data. The step (S300) may be called a third step (S300). The third data generated in the step (S300) may correspond to the cargo movement route 400 illustrated in FIG. 4A.

The cargo shipment method (S10) according to the preferred embodiment of the present disclosure includes a step (S400) of generating subdivided cargo shipment zone data. The step (S400) of generating subdivided cargo shipment zone data is included in the planning step (S50). The step (S400) is carried out by the control unit 11 (refer to FIG. 1). The subdivided cargo shipment zone data may be called the fourth data. In the step (S400), the control unit 11 (refer to FIG. 1) generates the fourth data based on the third data. The step (S400) may be called a fourth step (S400). The fourth data generated in the step (S400) may correspond to the subdivided cargo shipment zones 311, 312, 313, 314, 315, 321, 322, 323, 331, 332, 333, 334 and 335 illustrated in FIG. 4B.

The cargo shipment method (S10) according to the preferred embodiment of the present disclosure includes a step (S500) of generating subdivided cargo shipment zone data having order of priority. The step (S500) of generating subdivided cargo shipment zone data having order of priority is included in the planning step (S50). The step (S500) is carried out by the control unit 11 (refer to FIG. 1). The subdivided cargo shipment zone data having order of priority may be called the fifth data. In the step (S500), the control unit 11 (refer to FIG. 1) generates the fifth data based on the fourth data. The step (S500) may be called a fifth step (S500). The fifth data generated in the step (S500) may correspond to the subdivided cargo shipment zones P1, P2, P3 and P4 having order of priority illustrated in FIG. 5.

The cargo shipment method (S10) according to the preferred embodiment of the present disclosure includes a step (S600) of judging implementability of the subdivided cargo shipment zone data having order of priority. The step (S600) is carried out by the control unit 11 (refer to FIG. 1). The control unit 11 (refer to FIG. 1) verifies implementability or realizability of the fifth data in the step (S600). For instance, in the step (S600), the control unit 11 (refer to FIG. 1) can verify the fifth data by simulation. The step (S600) may be called a verification step (S600). In the step (S600), if the control unit 11 (refer to FIG. 1) judges that the fifth data is not implementable, the control unit 11 carries out the planning step (S50). The step (S600) may be called a sixth step (S600). In the step (S600), the control unit 11 (refer to FIG. 1) carries out simulation based on the fifth data in order to know whether cargo can reach a designated location of the ship.

The cargo shipment method (S10) according to the preferred embodiment of the present disclosure includes a step (S700) of generating cargo shipment order data. The step (S700) may be called a seventh step (S700). In the step (S600), if the control unit 11 (refer to FIG. 1) judges that the fifth data is implementable, the control unit 11 carries out the step (S700). In the step (S700), the control unit 11 (refer to FIG. 1) may set the fifth data as the cargo shipment order data. FIG. 8 illustrates cargoes A, B and C (refer to FIG. 7) shipped on the ship 100 (refer to 100) are arranged by the cargo shipment order data generated in the step (S700).

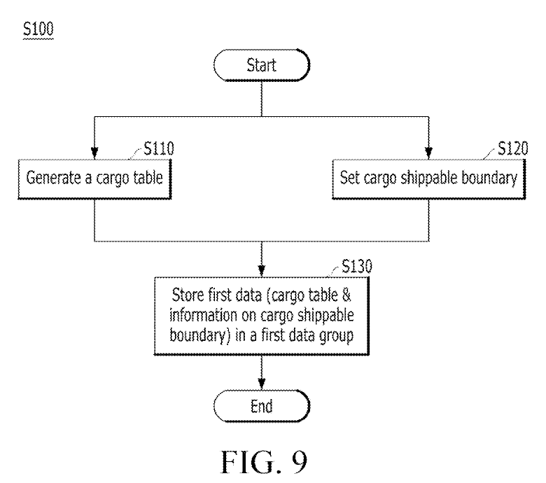

Referring to FIG. 9, the first step (S100) includes a step (S110) of generating a cargo table. The step (S110) is carried out by the control unit 11 (refer to FIG. 1). In the step (S110), the control unit 11 (refer to FIG. 1) acquires information on the cargo, which will be shipped on the ship 100 (refer to FIGS. 2A-2B), from the external organization 20 (refer to FIG. 1), and generates the cargo table 200 (refer to FIG. 3A) based on the information on the cargo. Moreover, in the step (S110), the control unit 11 (refer to FIG. 1) acquires the cargo table 200 (refer to FIG. 3A) from the external organization 20 (refer to FIG. 1).

The first step (S100) includes a step (S120) of setting a cargo shipment boundary. Information on the cargo shipment boundary may correspond to the cargo shippable zones 125 (refer to FIGS. 2A-2B). In the step (S120), the control unit 11 (refer to FIG. 1) acquires the structure-related information of the ship 100 (refer to FIGS. 2A-2B) from the external organization 20 (refer to FIG. 1), and sets the cargo shippable zones 125 (refer to FIGS. 2A-2B) based on the structure-related information of the ship. The first step (S100) includes a step (S130) of storing the first data in a first data group. The first data includes information on the cargo table 200 (refer to FIG. 3A) and the cargo shippable zones 125 (refer to FIGS. 2A-2B). The first data group includes the first data by a plurality of examples. The step (S130) is carried out by the control unit 11 (refer to FIG. 1).

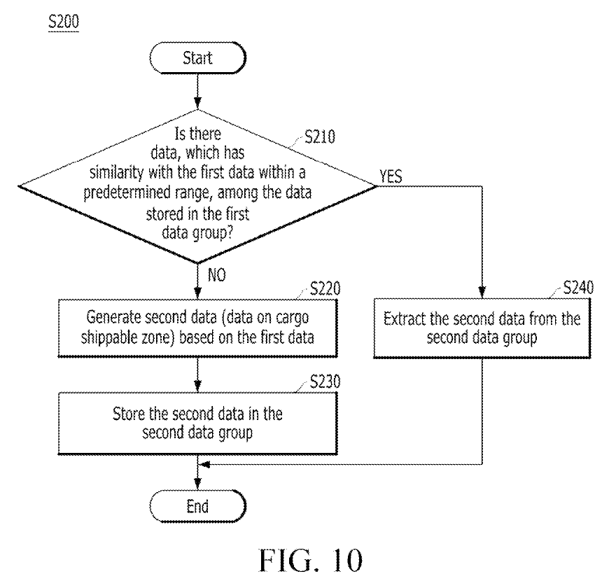

Referring to FIG. 10, the second step (S200) includes a step (S210) of judging whether there is data, which has similarity with the first data within a predetermined range, among the data stored in the first data group. In the step (S210), the control unit 11 (refer to FIG. 1) judges whether there is data identical or similar to the first data within a predetermined range, among data stored in the first data group. The second step (S200) includes a step (S220) of generating second data based on the first data. If it is judged that there is no data identical or similar to the first data within a predetermined range, among data stored in the first data group, in the step (S220), the control unit 11 (refer to FIG. 1) generates the second data based on the first data. The second step (S200) includes a step (S230) of storing the second data in the second data group. The second data group is linked with the first data group. For instance, the first data and the second data according to a plurality of the examples may be linked together by examples. The step (S230) is carried out by the control unit 11 (refer to FIG. 1). The second step (S200) includes a step (S240) of extracting the second data from the second data group. The step (S240) is carried out by the control unit 11 (refer to FIG. 1). If it is judged that there is data identical or similar to the first data within a predetermined range, among data stored in the first data group, in the step (S240), the control unit 11 (refer to FIG. 1) extracts the second data linked with the similar first data from the second data group.

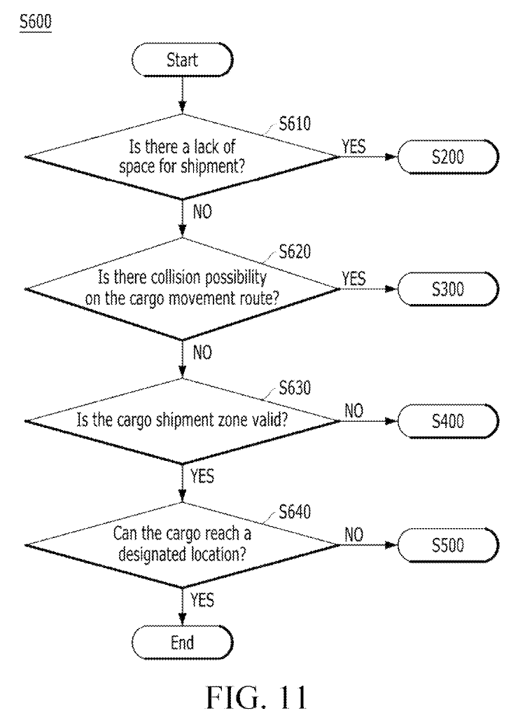

Referring to FIG. 11, the sixth step (S600) includes a step (S610) of judging whether there is a lack of a space for shipment. The step (S610) is carried out by the control unit 11 (refer to FIG. 1). The control unit 11 (refer to FIG. 1) verifies the fifth data. If it is judged that there is a lack of a space for shipment, the control unit 11 carries out the second step (S200). The sixth step (S600) includes a step (S620) of judging whether there is collision possibility on the cargo movement route. If it is judged that the space for shipment is enough, the control unit 11 (refer to FIG. 1) carries out the step (S620). The control unit 11 (refer to FIG. 1) verifies the fifth data. If it is judged that there is collision possibility on the cargo movement route, the control unit 11 carries out the third step (S300). The sixth step (S600) includes a step (S630) of judging whether the cargo shipment zones are valid. If it is judged that there is no collision possibility on the cargo movement route, the control unit 11 (refer to FIG. 1) carries out the step (S630). The control unit 11 (refer to FIG. 1) verifies the fifth data. If it is judged that the cargo shipment zones are not valid, the control unit 11 carries out the fourth step (S400). The sixth step (S600) includes a step (S640) of judging whether the cargo can reach the designated location. If it is judged that the cargo shipment zones are valid, the control unit 11 (refer to FIG. 1) carries out the step (S640). After verification of the fifth data, if it is judged that the cargo cannot reach the designated location, the control unit 11 (refer to FIG. 1) carries out the fifth step (S500). The control unit 11 (refer to FIG. 1) verifies the fifth data. If it is judged that the cargo can reach the designated location, the control unit 11 carries out the seventh step (S700) (refer to FIG. 8).

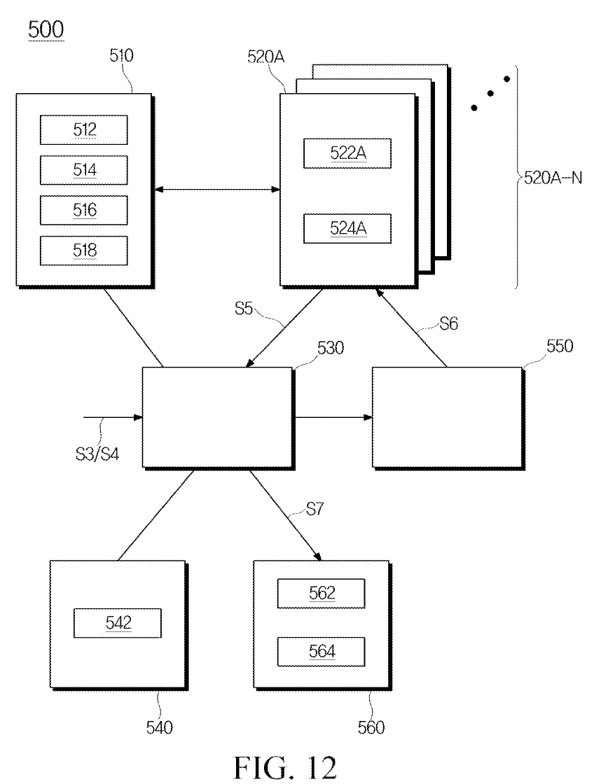

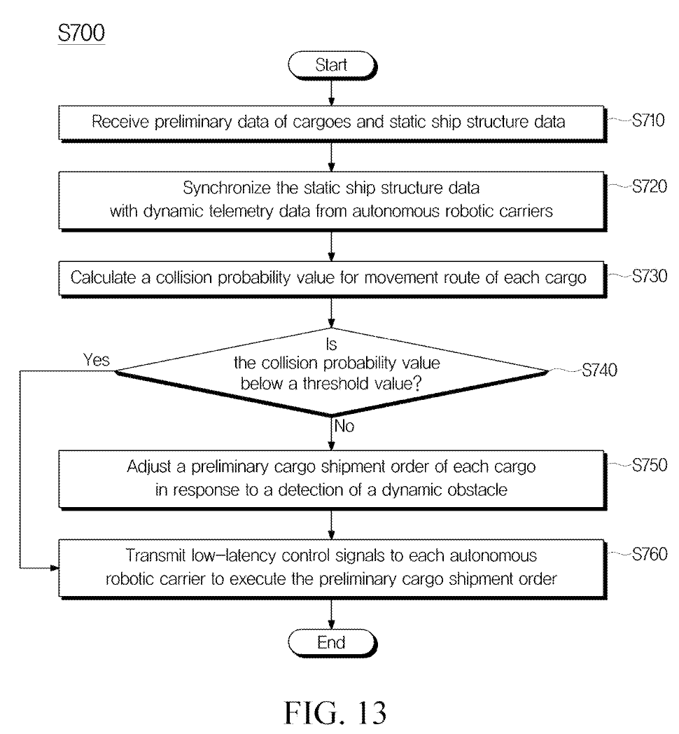

FIG. 12 illustrate another system for setting an order of cargo shipment according to one embodiment of the present disclosure. FIG. 13 is a flow chart showing another cargo shipping method according to one embodiment of the present disclosure.

As illustrated in FIGS. 12 and 13, an autonomous robotic cargo management system 500 for internal ship logistics comprises a multi-spectral sensor suite 510, one or more autonomous robotic carriers 520A-N, a computer processor 530, a memory 540, and a navigation control system 550. The multi-spectral sensor suite 510 comprises at least an ultrasonic dimensioning sensor 512 to measure three-dimensional profiles of cargoes within the ship 100. The multi-spectral sensor suite 510 may include additional sensors, such as an ultra-wideband (UWB) sensor 514, a lidar sensor 516, or a radar sensor 518 configured to track real-time spatial coordinates of the cargoes within the ship 100.

In the context of the robotic cargo management system 500, the multi-spectral sensor suite 510 is strategically installed in multiple locations to create a comprehensive, real-time map of the internal environment of the ship 100. Based on the technical requirements for measuring cargo profiles and tracking autonomous carriers, these sensors are typically located on the autonomous robotic carriers 520A-N. For instance, the lidar sensor 516 or the radar sensor 518 is mounted on the front, rear, and/or sides of the autonomous robotic carriers 520A-N to provide a 360° field of view for dynamic obstacle avoidance. The UWB sensor 514 is positioned at lower levels on the chassis of the autonomous robotic carriers 520A-N to detect near-field obstacles, to assist in precise docking with cargoes, or to transmit the spatial coordinates of the autonomous robotic carriers 520A-N. Alternatively, the multi-spectral sensor suite 510 is positioned at fixed points throughout the deck, loading zones, ceiling/bulkhead mounts, ramps and pillars within the ship 100. As the cargoes enter the ship 100, the multi-spectral sensor suite 510 measures the three-dimensional (3D) profiles of the cargoes to update the cargo table 200 in FIG. 3A before the autonomous robotic carriers 520A-N take over for internal transport.

The autonomous robotic carriers 520A-N move the cargoes to destinations within the ship 100 and each one of the autonomous robotic carriers 520A-N comprises a drive system 522A-N and a wireless transceiver 524A-N for receiving navigation commands (S6) from the navigation control system 550. It is appreciated that each one of the drive systems 522A-N is the core hardware assembly responsible for the physical execution of movement commands generated by the navigation control system 550. In the context of ship logistics, it transforms digital instructions into the mechanical force required to transport a heavy cargo along a cargo movement route.

The computer processor 530 executes instructions 542 stored in the memory 540 to cause the computer processor 530 to perform a method illustrated in FIG. 13. In step 710 (S710), the computer processor 530 receives preliminary data (S3) of the cargoes and static ship structure data (S4) identifying fixed internal obstacles including pillars and ramps within the ship 100 from an external or internal source and synchronizes the static ship structure data (S4) with dynamic telemetry data (S5) from the autonomous robotic carriers 520A-N in Step 720 (S720). In step 730 (S730), the computer processor 530 calculates a numerical collision probability value for movement route of each cargo by executing a predictive interference analysis between a projected kinematic path of each autonomous robotic carrier (e.g., 520A) carrying each cargo and an occupancy volume of the static ship structure data (S4) and a three-dimensional profile of each cargo.

It is appreciated that the predictive interference analysis may be the computational process used to identify potential physical overlaps between moving and static objects before they occur. The system 500 synchronizes the static ship structure data (S4) (e.g., fixed coordinates of pillars and ramps) with the three-dimensional profiles of the cargoes measured by the multi-spectral sensor suite 510. The computer processor 530 projects a kinematic path - a mathematical model of the autonomous robotic carrier’s future movement based on its current dynamic telemetry data (S5) (velocity, heading, and acceleration). The analysis creates a digital "safety envelope" around the moving cargoes and compares them against the "occupancy volume" of internal ship structures. If the projected path of any autonomous robotic carrier intersects with the volume of a pillar or another cargo, the analysis identifies a "collision event."

While the interference analysis finds the conflict, the numerical collision probability value provides the mathematical certainty required to decide whether to proceed or regenerate the plan. This is the ratio of predicted collision events to the total number of possible occurrences (or total calculated movement paths). The system 500 does not just "avoid" collisions; it assigns a specific numerical value (e.g., 0.05 or 5%) to the route. If the numerical collision probability value is below the threshold, the preliminary cargo shipment order is validated and sent to the navigation control system (550) for execution. If the numerical collision probability value is above the threshold, the order is invalidated, triggering an immediate path re-calculation or a complete regeneration of the shipment order. Because the multi-spectral sensor suite 510 (e.g., the lidar sensor 516, the radar sensor 518) provides continuous streams of data, this numerical value is constantly updated as the autonomous robotic carriers 520A-N moves along the cargo movement route.

In step 740 (S740), the computer processor 530 evaluates whether the collision probability value is below a threshold value. If the answer is ‘YES,’ the computer processor 530 validates a preliminary cargo shipment order of each cargo by transmitting low-latency control signals (S6) to each autonomous robotic carrier directly from the computer processor 530 or via the navigation control system 550 to execute the validated or adjusted cargo shipment order in step 760 (S760), wherein the preliminary cargo shipment order of each cargo is generated by fusing at least the preliminary data (S3) of the cargoes with the static ship structure data (S4). If the answer is ‘NO,’ the computer processor 530 adjusts the preliminary cargo shipment order in real-time by performing a path re-calculation in step 750 (S750). This may occur if the multi-spectral sensor suite 510 detects a dynamic obstacle. Once the preliminary cargo shipment order is adjusted, the computer processor 510 goes through step 760 (S760).

In one example embodiment, an alert signal S7 is transmitted to a management terminal 560 in response to a detection of the dynamic obstacle, wherein the management terminal 560 comprises a display unit 562 to visually alert an operator of the management terminal 560 and a speaker unit 564 to aurally alert the operator of the management terminal. In the context of the autonomous robotic cargo management system 500, the three-dimensional (3D) profile refers to the exact volumetric footprint and physical geometry of a piece of cargo as measured in real-time by the multi-spectral sensor suite 510. Rather than relying solely on the static "size" listed in a preliminary cargo table, the system uses its multi-spectral sensors - specifically the lidar sensor 516 and the ultrasonic dimensioning sensor 512 - to generate a high-precision digital map of the cargoes.

Components of the 3D profile includes volumetric dimensions, which are precise length, width, and height of the cargo, including any irregular protrusions (such as side mirrors on a vehicle or pallets) that might not be in the standard documentation. The components also include an occupancy volume, which is the total space the cargo occupies within the ship's coordinates. The occupancy volume is used to calculate the "predictive interference analysis" against fixed structures like pillars or other stored cargo. The components further include spatial orientation, which is the real-time "heading" or rotation of the cargo relative to the ship's internal passages. The spatial orientation is critical for determining if the autonomous robotic carriers 520A-N can navigate a specific "subdivided cargo shipment zone."

The autonomous robotic cargo management system 500 compares the 3D profile's projected movement path against the "occupancy volume" of static ship structures (e.g., pillars, ramps) to calculate the numerical likelihood of a strike. The system 500 verifies in real-time whether there is a "lack of space" in a specific loading zone by comparing the cargo's measured 3D profile against the available free space detected by the sensor suite 510. If the 3-D profile of the cargo is found to be larger than expected or if its orientation changes during transit, the computer processor 530 performs a "path re-calculation" to avoid internal obstacles.

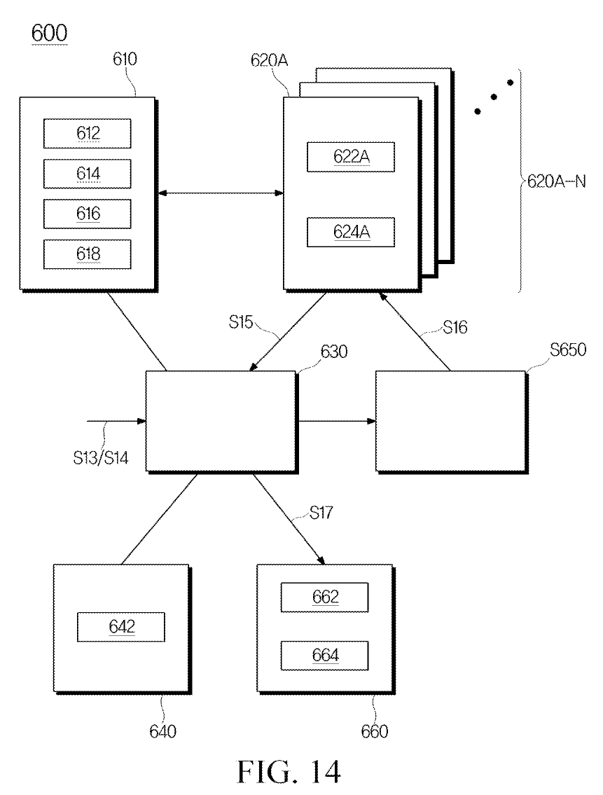

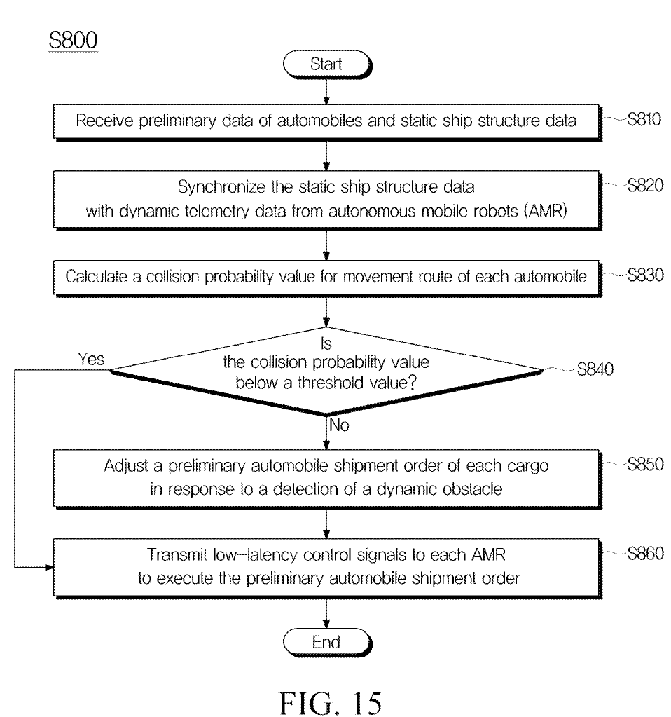

FIG. 14 illustrate yet another system for setting an order of cargo shipment according to one embodiment of the present disclosure. FIG. 15 is a flow chart showing yet another cargo shipping method according to one embodiment of the present disclosure.

As illustrated in FIGS. 14 and 15, an autonomous robotic automobile management system 600 for internal ship logistics of roll-on/roll-off (RoRo) ship comprises a multi-spectral sensor suite 610, one or more autonomous mobile robots (AMRs) 620A-N, a computer processor 630, a memory 640, and a navigation control system 650. The multi-spectral sensor suite 610 comprises a lidar sensor 612 to track real-time spatial coordinates of the automobiles within the RoRo ship.

It is appreciated that the AMRs 620A-N represent the autonomous robotic carriers 520A-N that execute the movement of cargo within the ship. The AMRs 620A-N use the multi-spectral sensor suite 610 to create a 3D map of their surroundings, allowing them to move without fixed infrastructure. The AMRs 620A-N may be ideal for the complex environment of the RoRo ship, where they must synchronize with the static ship structure data (S14) while avoiding other moving carriers. In place of the AMRs 620A-N, automated guided vehicles (AGVs) may be used, where the AGVs are robotic carriers that follows fixed paths, similar to a train on invisible tracks.

The multi-spectral sensor suite 610 may include additional sensors, such as an ultra-wideband (UWB) sensor 614 and a radar sensor 616, to track real-time spatial coordinates of the automobiles within the ship. It is appreciated that the RoRo ship may allow vehicles or automobiles to be driven directly on to the ship via built-in ramps rather than relying on cranes to life automobiles.

The autonomous robotic carriers 620A-N move the automobiles to destinations within the ship, and each AMR 620A-N comprises a drive system 622A-N and a wireless transceiver 624A-N for receiving navigation commands (S16) from the navigation control system 650. The computer processor 630 executes instructions 642 stored in the memory 640 to cause the computer processor 630 to perform a method illustrated in FIG. 15. In step 810 (S810), the computer processor 630 receives preliminary data (S13) of the automobiles and static ship structure data (S14) identifying fixed internal obstacles including pillars and ramps within the ship and synchronizes the static ship structure data (S14) with dynamic telemetry data (S15) from the AMR 620A-N in Step 820 (S820). In step 830 (S830), the computer processor 630 calculates a numerical collision probability value for movement route of each automobile by executing a predictive interference analysis between a projected kinematic path of each AMR (e.g., 620A) carrying each automobile and an occupancy volume of the static ship structure data (S14) and a three-dimensional profile of each automobile.

In step 840 (S840), the computer processor 630 evaluates whether the collision probability value is below a threshold value. If the answer is ‘YES,’ the computer processor 630 validates a preliminary automobile shipment order of each automobile by transmitting low-latency control signals (S16)) to each AMR 620A-N to execute the validated or adjusted automobile shipment order in step 860 (S860), wherein the preliminary automobile shipment order of each automobile is generated by fusing at least the preliminary data of the automobiles with the static ship structure data (S14). If the answer is ‘NO,’ the computer processor 630 adjusts the preliminary automobile shipment order in real-time by performing a path re-calculation in step 850 (S850). This may occur if the multi-spectral sensor suite 610 detects a dynamic obstacle. Once the preliminary automobile shipment order is adjusted, the computer processor 610 goes through step 860 (S860).

In one example embodiment, an alert signal (S17) is transmitted to a management terminal 660 in response to a detection of the dynamic obstacle, wherein the management terminal 660 comprises a display unit 662 to visually alert an operator of the management terminal 660 and a speaker unit 664 to aurally alert the operator of the management terminal 660. The dynamic telemetry data (S15) comprises UWB coordinates of the AMRs 620A-N. As illustrated in FIG. 3B, the automobiles may be grouped into a plurality of groups based on their sizes (e.g., Group A, Group B, and Group C in FIG. 3B). The static ship structure data comprises a map of a deck of the RoRo ship, and the deck is divided into a plurality of zones having an order of priority, as illustrated in FIG. 5. The multi-spectral sensor suite 610 may be installed in multiple locations of the RoRo ship and on the AMRs 620A-N.

The above description of the present disclosure is just for illustration, and a person skilled in the art will understand that the present disclosure can be easily modified in different ways without changing essential techniques or features of the present disclosure. Therefore, the above embodiments should be understood as being descriptive, not limitative. For example, any component described as having an integrated form may be implemented in a distributed form, and any component described as having a distributed form may also be implemented in an integrated form. The scope of the present disclosure is defined by the appended claims, rather than the above description, and ail changes or modifications derived from the meaning, scope and equivalents of the appended claims should be interpreted as falling within the scope of the present disclosure.

This research was supported by Korea Institute of Marine Science & Technology Promotion(KIMST) funded by the Ministry of Oceans and Fisheries(RS-2025-02305446).

What is claimed is:

1. An autonomous robotic cargo management system for internal ship logistics, comprising:
a multi-spectral sensor suite comprising an ultrasonic dimensioning sensor, the multi-spectral sensor suite configured to measure three-dimensional profiles of cargoes within a ship;
at least one autonomous robotic carrier to move the cargoes to destinations within the ship and each one of the at least one autonomous robotic carrier comprising a drive system and a wireless transceiver for receiving navigation commands;
a computer processor and a memory storing instructions that, when executed, cause the computer processor to:
receive preliminary data of the cargoes and static ship structure data identifying fixed internal obstacles including pillars and ramps within the ship;
synchronize the static ship structure data with dynamic telemetry data from the at least one autonomous robotic carrier;
calculate a numerical collision probability value for movement route of each cargo by executing a predictive interference analysis between a projected kinematic path of each autonomous robotic carrier carrying the each cargo and an occupancy volume of the static ship structure data and a three-dimensional profile of the each cargo;
validate a preliminary cargo shipment order of the each cargo if the numerical collision probability value for the movement route of the each cargo is below a threshold value and confirms a destination reachability, wherein the preliminary cargo shipment order of the each cargo is generated by fusing at least the preliminary data of the cargoes with the static ship structure data; and
adjust the preliminary cargo shipment order in real-time by performing a path re-calculation if the multi-spectral sensor suite detects a dynamic obstacle; and
a navigation control system configured to autonomously direct the each autonomous robotic carrier by transmitting low-latency control signals to the each autonomous robotic carrier to execute the validated or adjusted cargo shipment order.

2. The system of claim 1, wherein the computer processor is configured to transmit an alert signal to a management terminal in response to a detection of the dynamic obstacle.

3. The system of claim 2, wherein the management terminal comprises:
a display unit to visually alert an operator of the management terminal; and
a speaker unit to aurally alert the operator of the management terminal.

4. The system of claim 1, wherein the multi-spectral sensor suite further comprises an ultra-wideband sensor, a lidar sensor, or a radar sensor configured to track real-time spatial coordinates of the cargoes within the ship.

5. The system of claim 1, wherein the dynamic telemetry data comprises kinematic and positional data of the at least one autonomous robotic carrier.

6. The system of claim 1, wherein the at least one autonomous robotic carrier comprises an ultra-wideband (UWB) sensor configured to transmit UWB coordinates of the at least one autonomous robotic carrier.

7. The system of claim 1, wherein the at least one autonomous robotic carrier comprises an automated guided vehicle (AGV) or an autonomous mobile robot (AMR).

8. A method of an autonomous robotic cargo management system for internal ship logistics, the autonomous robotic cargo management system comprising:
a multi-spectral sensor suite comprising an ultrasonic dimensioning sensor, the multi-spectral sensor suite configured to measure three-dimensional profiles of cargoes within a ship;
at least one autonomous robotic carrier to move the cargoes to destinations within the ship and each one of the at least one autonomous robotic carrier comprising a drive system and a wireless transceiver for receiving navigation commands;
a computer processor;
a memory; and
a navigation control system,
wherein the memory is configured to store instructions that, when executed, cause the computer processor to perform the method comprising:
receiving preliminary data of the cargoes and static ship structure data identifying fixed internal obstacles including pillars and ramps within the ship;
synchronizing the static ship structure data with dynamic telemetry data from the at least one autonomous robotic carrier;
calculating a numerical collision probability value for movement route of each cargo by executing a predictive interference analysis between a projected kinematic path of each autonomous robotic carrier carrying the each cargo and an occupancy volume of the static ship structure data and a three-dimensional profile of the each cargo;
validating a preliminary cargo shipment order of the each cargo if the numerical collision probability value for the movement route of the each cargo is below a threshold value and confirms a destination reachability, wherein the preliminary cargo shipment order of the each cargo is generated by fusing at least the preliminary data of the cargoes with the static ship structure data;
adjusting the preliminary cargo shipment order in real-time by performing a path re-calculation if the multi-spectral sensor suite detects a dynamic obstacle; and
transmitting low-latency control signals to the each autonomous robotic carrier to execute the preliminary cargo shipment order to autonomously direct the each autonomous robotic carrier using the navigation control system.

9. The method of claim 8, wherein method further comprising transmitting an alert signal to a management terminal in response to a detection of the dynamic obstacle.

10. The method of claim 9, wherein the management terminal comprises:
a display unit to visually alert an operator of the management terminal; and
a speaker unit to aurally alert the operator of the management terminal.

11. The system of claim 8, wherein the multi-spectral sensor suite further comprises an ultra-wideband sensor, a lidar sensor, or a radar sensor configured to track real-time spatial coordinates of the cargoes within the ship.

12. The system of claim 8, wherein the dynamic telemetry data comprises kinematic and positional data of the at least one autonomous robotic carrier.

13. An autonomous robotic cargo management system for internal ship logistics of a roll-on/roll-off (RoRo) ship carrying automobiles, comprising:
a multi-spectral sensor suite comprising a lidar sensor, the multi-spectral sensor suite configured to track real-time spatial coordinates of the automobiles within the RoRo ship;
at least one autonomous mobile robot (AMR) to move the automobiles to destinations within the RoRo ship and each one of the at least one AMR comprising a drive system and a wireless transceiver for receiving navigation commands;
a computer processor and a memory storing instructions that, when executed, cause the computer processor to:
receive preliminary data of the automobiles and static ship structure data identifying fixed internal obstacles including pillars and ramps within the RoRo ship;
synchronize the static ship structure data with dynamic telemetry data from the at least one AMR;
calculate a numerical collision probability value for movement route of each automobile by executing a predictive interference analysis between a projected kinematic path of each AMR carrying the each automobile and an occupancy volume of the static ship structure data and a three-dimensional profile of the each automobile;
validate a preliminary automobile shipment order of the each automobile if the numerical collision probability value for the movement route of the each automobile is below a threshold value and confirms a destination reachability, wherein the preliminary automobile shipment order of the each automobile is generated by fusing at least the preliminary data of the automobiles with the static ship structure data; and
adjust the preliminary automobile shipment order in real-time by performing a path re-calculation if the multi-spectral sensor suite detects a dynamic obstacle; and
a navigation control system configured to autonomously direct the each AMR by transmitting low-latency control signals to the each AMR to execute the validated or adjusted automobile shipment order.

14. The system of claim 13, wherein the computer processor is configured to transmit an alert signal to a management terminal in response to a detection of the dynamic obstacle.

15. The system of claim 14, wherein the management terminal comprises:
a display unit to visually alert an operator of the management terminal; and
a speaker unit to aurally alert the operator of the management terminal.

16. The system of claim 13, wherein the multi-spectral sensor suite further comprises an ultra-wideband sensor or a radar sensor configured to track real-time spatial coordinates of the cargoes within the ship.

17. The system of claim 13, wherein the dynamic telemetry data comprises UWB coordinates of the at least one AMR.

18. The system of claim 13, wherein the automobiles are grouped into a plurality of groups based on their sizes.

19. The system of claim 13, wherein the static ship structure data comprises a map of a deck of the RoRo ship, and wherein the deck is divided into a plurality of zones having an order of priority.

20. The system of claim 13, wherein the multi-spectral sensor suite is installed in multiple locations of the RoRo ship and on the AMR.
